(19) United States
(12) Patent Application Publication
(10) Pub. No.: US 2009/0311572 A1
(43) Pub. Date: Dec. 17, 2009

(54) INTEGRATED FUEL CELL AND MANUFACTURING METHOD

(75) Inventors: Mathieu Roy, Joue Les Tours (FR); Fabien Pierre, Saint Cyr Sur Loire (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.A., Montrouge (FR)

(21) Appl. No.: 12/159,088

(22) PCT Filed: Dec. 27, 2006
(86) PCT No.: PCT/FR2006/051430

§ 371 Date: Jan. 28, 2009

(30) Foreign Application Priority Data
Dec. 27, 2005 (FR) 0554104

(51) Int. Cl. H01M 2/02; H01M 4/82

(52) U.S. Cl. 429/34; 29/623.5

(57) ABSTRACT

A fuel cell having its active stack resting on a thin conductive layer, bearing on a wafer provided with through gas inlet channels, the thin conductive layer protruding in the active stack in front of each channel and being transparent to the gas.

### BACKGROUND OF THE INVENTION

1. Field of the Invention

The present invention relates to a fuel cell and a method for manufacturing an integrated fuel cell.

2. Discussion of the Related Art

FIG. 1 shows an example of an integrated fuel cell formed by using microelectronics techniques. This cell is formed on a support wafer formed of a silicon wafer 1 coated with a first thin insulating layer 2 and with a second thicker insulating layer 3. An opening is formed in a portion of insulating layer 3. A support layer 4, a catalyst layer 5, an electrolyte 6, and a second catalyst layer 7 are successively deposited in this opening. These layers altogether form an active stack 8. An electrode 10, placed on first insulating layer 2, is in contact with support layer 4 on the lower fuel cell surface side. An opening 11 in second insulating layer 3 provides access to electrode 10. An upper electrode 12 is in contact with upper catalyst layer 7. Electrodes 10 and 12 are provided with openings, and channels 13 are formed in silicon wafer 1 opposite to the openings in the lower surface metallization. Lower electrode 10 and upper electrode 12 respectively form an anode collector and a cathode collector.

Electrolyte 6 for example is a polymer acid such as Nafion in solid form and the catalyst layers for example are carbon- and platinum-based layers. This is an example of embodiment only. Various types of fuel cells that can be formed as illustrated in FIG. 1 are known in the art.

To operate the fuel cell, hydrogen is injected along arrow H₂ on the lower surface side and air (carrying oxygen) is injected on the upper surface side. The hydrogen is “decomposed” at the level of catalyst layer 5 to form, on the one hand, H⁺ protons which direct towards electrolyte 6 and, on the other hand, electrons which direct, via the outside of the cell, towards anode collector 10. The H⁺ protons cross electrolyte 6 to reach catalyst layer 7 where they recombine with oxygen and electrons coming from the outside of the cell via the cathode collector. In a known fashion, with such a structure, a positive voltage is obtained on cathode collector 12 (on the oxygen side) and a negative voltage is obtained on anode collector 10 (on the hydrogen side).

A disadvantage of this type of fuel cell lies in the phenomena occurring at the level of the opening of hydrogen inlet channels 13. Instead of the reactions to occuring across the entire surface of lower catalyst layer 5, these reactions appear to in fact only take place on a portion of this surface substantially corresponding to the surface area taken up by the openings of the hydrogen inlet channels. In other words, the efficiency of this type of cell is reduced by a factor 2 or 3 with respect to what could be expected. It can be thought that this is due to the fact that support layer 4 penetrates at least partially into the channels and that catalyst layer 5 only interacts with hydrogen at the level of the opening of channels 13.

### SUMMARY OF THE INVENTION

An object of the present invention is to provide a novel integrated fuel cell structure enabling improving the electrochemical efficiency per surface area unit.

Another object of the present invention is to provide a method for manufacturing such a fuel cell.

Another object of the present invention is to provide such a fuel cell of simple structure.

To achieve these and other objects, the present invention provides a fuel cell having its active stack resting on a thin conductive layer, bearing on a wafer provided with through gas inlet channels, the thin conductive layer protruding in the active stack in front of each channel and being transparent to said gas.

According to an embodiment of the present invention, the thin conductive layer is a gold layer.

According to an embodiment of the present invention, the various active layers of the fuel cell follow the profile of the protrusions of the thin conductive layer.

The present invention also provides a method for manufacturing a fuel cell, comprising the steps of providing a support wafer; forming non-through channels from a first surface of the support wafer; coating said channels with a first material; forming a recess from the second surface of the wafer, this recess exposing the ends of the first material; depositing on the second surface a thin layer of a conductive material transparent to hydrogen; eliminating the first layer of the material at least under the thin layer of a conductive material; and forming in said recess a stack of layers capable of forming a fuel cell having a lower surface that can receive hydrogen.

According to an embodiment of the present invention, the materials of said stack of layers are deposited by an inkjet method.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 is a cross-section view of a known fuel cell;

FIGS. 2A to 2E are cross-section views illustrating successive steps of the manufacturing of a fuel cell according to the present invention; and

FIGS. 3 to 7 illustrate embodiments of the present invention.

### DETAILED DESCRIPTION

For clarity, as usual in the representation of integrated circuits, the elements of the various cross-section and perspective views are not to scale.

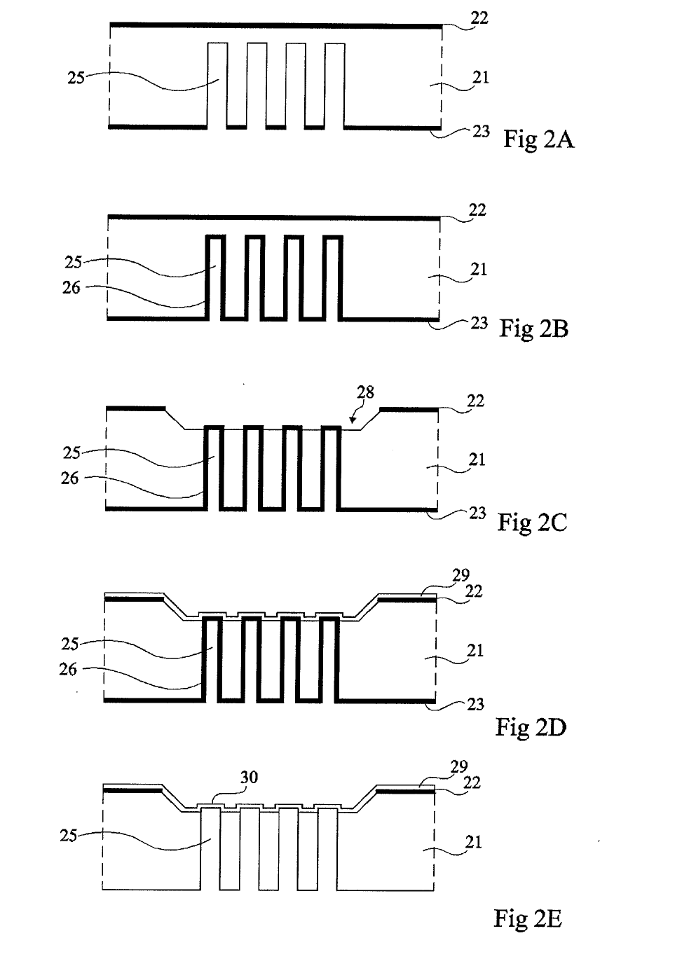

FIGS. 2A to 2E are simplified cross-section views illustrating successive steps of the manufacturing of a fuel cell according to the present invention. For this manufacturing, it is started from a support wafer. To simplify the present description, the case where this support wafer is made of silicon will be considered, but it should be understood by those skilled in the art that other types of materials may be used, which will result in corresponding adaptations in the selection of the associated methods, especially of the etch methods, and the selection of the insulation materials.

Thus, FIG. 2A shows a silicon wafer 21 coated on its upper and lower (or front and rear) surfaces with protection layers 22 and 23. Protection layer 23 on the rear surface side is etched to define openings therein. Channels 25 are formed according to the contours defined by these openings, by an anisotropic etch method, such as a plasma etching.

At the next step illustrated in FIG. 2B, a material 26 is deposited in channels 25 to coat their walls and their bottoms, as shown, or to fill them completely. As will be seen hereafter, this material should be selectively etchable with respect to silicon and to a metal. In an example of application of the present invention, coating 26 is formed of a silicon oxide layer obtained by thermal growth. Protection layers 22 and 23 may also be made of silicon oxide, for example, obtained by deposition.

At the step illustrated in FIG. 2C, an opening is defined in upper protection layer 22 and a recess 28 is etched in the front surface of wafer 21. Recess 28 is deep enough to extend beyond the bottoms of channels 25 covered with layer 26. The etching is such that it does not etch the material of layer 26 and that there thus remain protrusions of the material of layer 26 at the bottom of recess 28. According to the manufacturing mode, these protrusions will have different shapes, according to the shape of the bottoms of the channels resulting from the plasma etch, or another etch for forming these channels. The protrusions will, for example, have the shape of rounded domes.

At the step illustrated in FIG. 2D, a layer of a metal or of an alloy sufficiently thick to be a good electrical conductor and sufficiently thin to be transparent to hydrogen has been deposited on the upper surface of the structure. A gold layer of a thickness on the order of 500 nm may for example be selected.

Then, at the step illustrated in FIG. 2E, the material of layer 26 is eliminated, at least at the bottom of channels 25, where this layer is covered with conductive layer 29. Protrusions 30 of gold layer 29 are then kept.

As an example of order of magnitude, it should be noted that support wafer 21, in the case where it is a silicon wafer, may have a thickness on the order of from 300 to 500 μm, that channels 25 may be circular perforations with a diameter on the order of from 40 to 50 μm, with a step from 40 to 50 μm, and that the general perforated area may have a surface area on the order of one cm². Protrusions 30 of gold layer 29 may have a height from 10 to 20 μm.

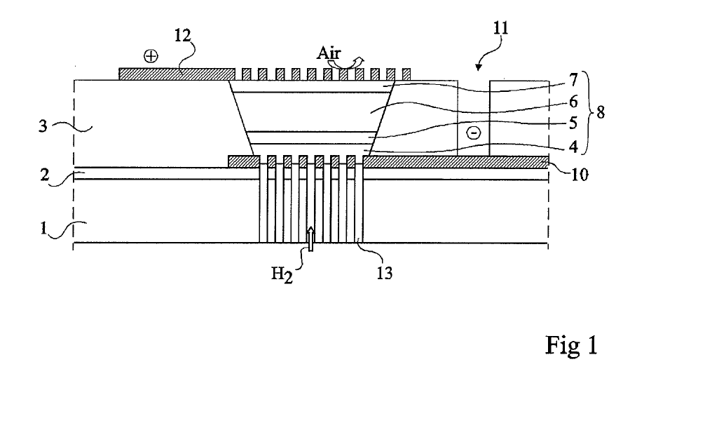

From the structure obtained in FIG. 2E, the deposition of active stack 8 described in relation with FIG. 1 may be performed, it being understood that, in this active stack, support 4 is not necessary. Indeed, this support layer had the purpose of avoiding that the material of first catalyst layer 5 goes back down into the channels. The relief shape, possibly bulged, of gold protrusions 30 results in that hydrogen leaves channels 23 upwards and sideways and disperses better in the lower catalyst layer.

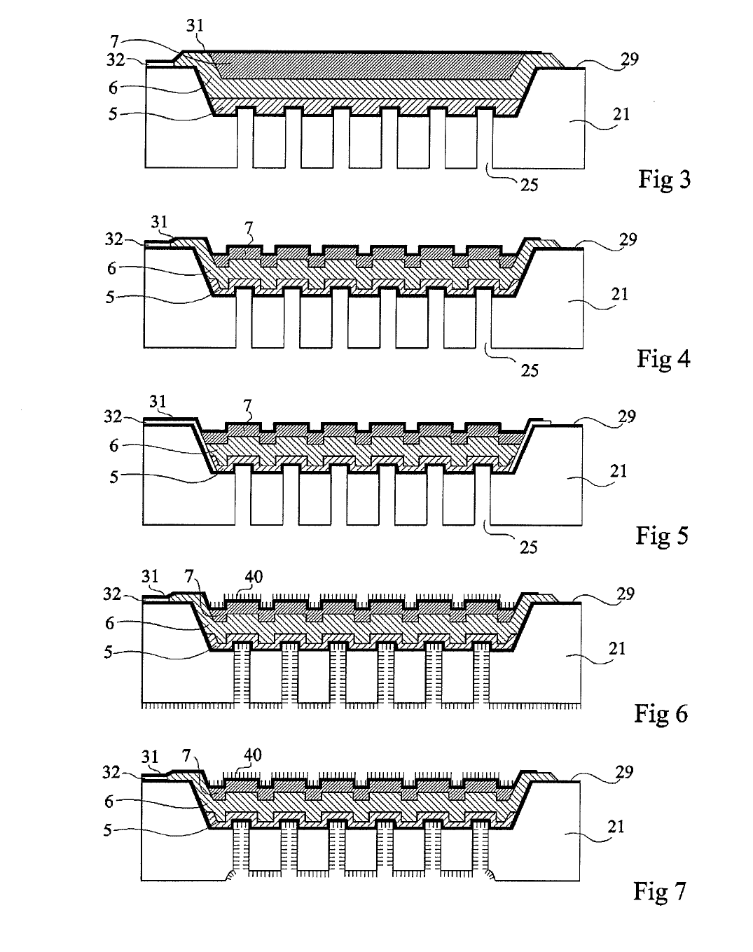

Various ways to form active stack 8 will be described in relation with FIGS. 3 to 7. In these drawings, the support wafer is designated with reference numeral 21, the channels are designated with reference numeral 25, the thin conductive layer transparent to hydrogen is designated with reference numeral 29, the first catalyst layer is designated with reference numeral 5, the electrolyte layer is designated with reference numeral 6, the second catalyst layer is designated with reference numeral 7, and the upper electrode, perforated or transparent to oxygen is designated with reference numeral 31.

In the embodiment of FIG. 3, first catalyst layer 5 is deposited to have a substantially planar upper surface. Electrolyte layer 6 is deposited to provide a substantially constant thickness (conformal deposition) and second catalyst layer 7 is deposited to be present only in the central basin of catalyst layer 6 resulting from the conformal deposition thereof. An insulator 32 is formed at the locations where first conductive layer 29 risks being in contact with second conductive layer 31.

FIG. 4 shows a second embodiment of the present invention in which each of the depositions of active layer 5, 6, and 7 is a conformal deposition. In this embodiment, the upper catalyst layer does not come into contact with first electrode 29.

FIG. 5 illustrates another conformal deposition embodiment in which the upper metallization layer comes into contact with the edge of recess 28 and would thus risk being in short-circuit with lower electrode 29. To avoid this short-circuit risk, insulating layer 32 is prolonged to extend on the lateral walls of recess 28 in which the active layers are formed.

According to an aspect of the present invention, the depositions of the materials of layers 5, 6, and 7 may be performed by ink jet, current technologies providing pattern definitions on the order of a few tens of μm, which is compatible with the elementary dimensions of the cells according to the present invention in which, as indicated previously, the perforations have diameters on the order of some fifty μm.

The variations illustrated in FIGS. 4 and 5 are intended to increase the contact surface area between the various active layers and between the catalyst layers and the hydrogen and oxygen inlet areas, to increase the efficiencies of the involved cells.

The embodiments of FIGS. 6 and 7 use the structure of FIG. 5 and add thereto a growth of nanotubes, for example, carbon nanotubes on the upper and lower surfaces of the cell and especially in channels 25. The provision of such a lining with carbon nanotubes enables improving, on the one hand, the water management within the structure due to the hydrophobic character of the nanotubes and, on the other hand, the thermal management of the cell core due to the low thermal resistance of these nanotubes.

In the embodiment of FIG. 7, a recess has been formed on the lower wafer surface opposite to the perforated area. In this embodiment, this recess is intended to protect the carbon nanotubes. It should be noted that such a recess may be provided in the other embodiments to enable decreasing the height of the hydrogen inlet channels.

Of course, the present invention is likely to have various, alterations, improvements, and modifications which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A fuel cell having its active stack resting on a thin conductive layer, bearing on a wafer provided with through gas inlet channels, the thin conductive layer protruding in the active stack in front of each channel and being transparent to said gas.

2. The fuel cell of claim 1, wherein the thin conductive layer is a gold layer.

3. The fuel cell of claim 1, wherein the various active layers of the fuel cell conform to the profile of the protrusions of the thin conductive layer.

4. A method for manufacturing a fuel cell, comprising the steps of:
providing a support wafer;
forming non-through channels from a first surface of the support wafer;
coating said channels with a first material;
forming a recess from the second surface of the wafer, this recess exposing the ends of the first material;
depositing on the second surface a thin layer of a conductive material transparent to hydrogen;
eliminating the first layer of the material at least under the thin layer of a conductive material; and
forming in said recess a stack of layers capable of forming a fuel cell having a lower surface that can receive hydrogen.

5. The method of claim 4, wherein the materials of said stack of layers are deposited by an inkjet method.
